(19) United States
(12) Patent Application Publication
(10) Pub. No.: US 2008/0104016 A1
(43) Pub. Date: May 1, 2008

(54) METHOD AND SYSTEM FOR COMPARING DATA

(76) Inventor: Susan Handayani Putri Atmaja, Singapore (SG)

Correspondence Address: DUKE W. YEE;YEE & ASSOCIATES, P.C., P.O. BOX 802333, DALLAS, TX, 75380, US

(21) Appl. No.: 11/554,399

(22) Filed: Oct. 30, 2006

(51) Int. Cl. G06F 17/30

(52) U.S. Cl. 707/2

(57) ABSTRACT

A system for comparing data. In response to retrieving data from a plurality of files according to file information, temporary files are generated for the plurality of files from the retrieved data using mapping information and at least one of a plurality of comparison rules. Then the temporary files are compared and a comparison report is generated.

### BACKGROUND OF THE INVENTION

1. Field of the Invention

The present invention relates generally to an improved data processing system. More specifically, the present invention is directed to a computer implemented method, system, and computer usable program code for comparing data from a plurality of spreadsheets.

2. Description of the Related Art

Today, businesses and organizations require vast quantities of useful information about their organizations, markets, and operations in order to survive in this information age. This useful business information needs to be condensed into a collection of data that is easy to understand and absorb. Businesses and organizations usually rely on software applications to condense, manipulate, or formulate these vast quantities of data into useful information. One of the most common software applications used to derive this useful business information from the vast data collections is a spreadsheet application.

A spreadsheet application allows a user to create and manipulate an electronic spreadsheet, which contains a table of values arranged in rows and columns. Sometimes a user may desire to compare two different electronic spreadsheets with one another. Typically, spreadsheet data file comparison is accomplished by the user creating paper copies of the spreadsheet files and then examining the spreadsheet files for the particular data comparison. This manual process may be extremely labor intensive and time consuming.

Alternatively, the user may utilize a spreadsheet comparison application to compare the two different electronic spreadsheets. A spreadsheet comparison application is computer software designed to compare two different electronic spreadsheets and produce a comparison report. However, current spreadsheet comparison applications only provide direct data comparison. In other words, the current spreadsheet comparison applications compare data as-is or in a direct one-to-one relationship. For example, the current spreadsheet comparison applications compare the first column of the first electronic spreadsheet file with the first column of the second electronic spreadsheet file without taking into account that the logical relationship that exists in the data, such as, for example, the data may have a column header that may not be placed within the first row of the column and the sequence of columns of the two electronic spreadsheets may not be in the same order. In addition, current spreadsheet comparison applications do not take into account that the data format of the compared columns may be different and that upper and lower case differentiations in the compared data may exist. As a result, the comparison report produced by these current spreadsheet comparison applications may be unintelligible or unreliable.

Therefore, it would be beneficial to have an improved computer implemented method, system, and computer usable program code for comparing data from a plurality of spreadsheets.

### BRIEF SUMMARY OF THE INVENTION

Illustrative embodiments provide a computer implemented method, system, and computer usable program code for comparing data. In response to retrieving data from a plurality of files according to file information, temporary files are generated for the plurality of files from the retrieved data using mapping information and at least one of a plurality of comparison rules. Then the temporary files are compared and a comparison report is generated.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 is a block diagram of a data processing system in which illustrative embodiments may be implemented;

FIG. 3 is an exemplary block diagram illustrating components for comparing data from a plurality of spreadsheets in accordance with an illustrative embodiment;

FIGS. 4A, 4B, and 4C are exemplary illustrations of data to be compared from a plurality of spreadsheets in accordance with an illustrative embodiment;

FIG. 5 is a pictorial representation of a column mapping information and comparison rules selection window in accordance with an illustrative embodiment; and

FIG. 6 is a flowchart illustrating an exemplary process for comparing data from a plurality of spreadsheets in accordance with an illustrative embodiment.

### DETAILED DESCRIPTION OF THE INVENTION

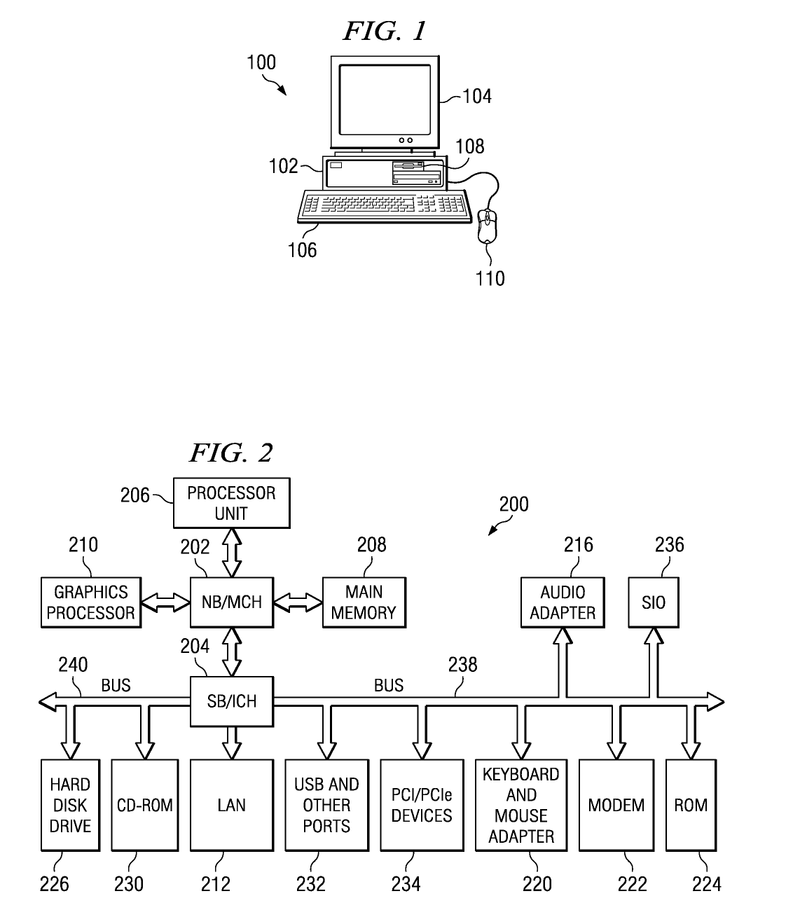

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices include a joystick, touchpad, touch screen, trackball, microphone, and the like.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may, for example, use an integrated drive electronics (IDE) or serial advanced technology attachment (SATA) interface. A super I/O (SIO) device 236 may be coupled to south bridge and I/O controller hub 204.

An operating system runs on processing unit 206. This operating system coordinates and controls various components within data processing system 200 in FIG. 2. The operating system may be a commercially available operating system, such as Microsoft® Windows XP®. Microsoft® and Windows XP® are trademarks of Microsoft Corporation in the United States, other countries, or both. An object oriented programming system, such as the Java ™ programming system, may run in conjunction with the operating system and provides calls to the operating system from Java ™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processing unit 206. The processes of the illustrative embodiments may be performed by processing unit 206 using computer implemented instructions, which may be located in a memory. An example of a memory is main memory 208, ROM 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, system, and computer usable program code for compiling source code and for executing code. The methods described with respect to the depicted embodiments may be performed in a data processing system, such as data processing system 100 shown in FIG. 1 or data processing system 200 shown in FIG. 2.

Illustrative embodiments provide a computer implemented method, system, and computer usable program code for comparing data. A spreadsheet comparison tool retrieves data from a plurality of spreadsheet files by utilizing user input spreadsheet file information, such as, for example, the specific spreadsheet files to compare, the specific columns within the spreadsheet files to compare, and the specific column header rows at which to start gathering data from the selected columns within the plurality of spreadsheet files. The spreadsheet comparison tool uses the selected column header rows to logically capture the column headers, which the spreadsheet comparison tool may use to facilitate data mapping and comparison.

After retrieving the user selected data to be compared from the plurality of spreadsheet files, the spreadsheet comparison tool generates temporary files for the plurality of spreadsheet files from the retrieved data using mapping information and comparison rules. The spreadsheet comparison tool stores the temporary files temporarily in volatile memory, such as, for example, main memory 208 in FIG. 2, until the spreadsheet comparison tool completes the spreadsheet file comparison process. In an alternative illustrative embodiment, the spreadsheet comparison tool may store the temporary files in non-volatile memory, such as hard disk 226 in FIG. 2, until, for example, a user deletes the temporary files. The temporary files only contain the user selected data to be compared from the plurality of spreadsheet files.

The mapping information also is input by the user. The mapping information includes instructions for the spreadsheet comparison tool to map data from one spreadsheet file within the plurality of spreadsheet files to associated data in another spreadsheet file within the plurality of spreadsheet files. In addition, the user inputs or selects which of the plurality of comparison rules the spreadsheet comparison tool uses during data comparison. The comparison rules include rules to ignore case sensitivity, data format, data prefixes, data postfixes, specific columns, and white space differentiation.

Subsequent to generating the temporary files, the spreadsheet comparison tool compares the temporary files and generates a comparison report. In addition, the spreadsheet comparison tool stores the comparison report in a storage device and displays the comparison report in a display screen for the user to view. Thus, a user utilizing illustrative embodiments may compare data from a plurality of spreadsheets even though the column sequence of data within the two electronic spreadsheets is not the same, the data format is different, upper and lower case differentiations in the compared data exists, white space differentiations between the two electronic spreadsheets exists, and data prefixes and/or postfixes are attached to the data to be compared.

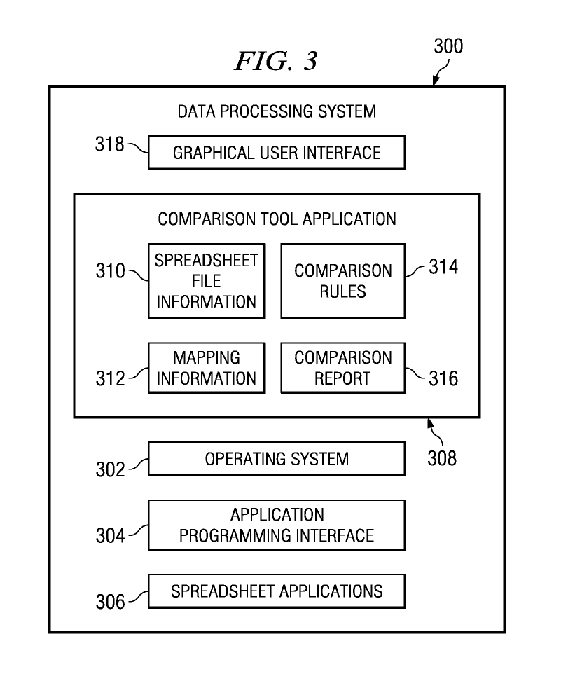

With reference now to FIG. 3, an exemplary block diagram illustrating components for comparing data from a plurality of spreadsheets is depicted in accordance with an illustrative embodiment. Data processing system 300 may, for example, be implemented in data processing system 200 in FIG. 2. However, it should be noted that the example depicted in FIG. 3 is only intended for the purpose of illustration and does not imply any architectural limitations on illustrative embodiments. Illustrative embodiments may include any components necessary to accomplish the task of comparing data from a plurality of spreadsheets.

In the depicted example of FIG. 3, data processing system 300 includes operating system 302, application programming interface (API) 304, spreadsheet applications 306, comparison tool application 308, GUI 318. Operating system 302 runs on a processor, such as processor unit 206 in FIG. 2, and provides high-level control of the components within data processing system 300. API 304 allows a user of data processing system 300, which may be an individual or a software routine, to invoke system capabilities using a standard consistent interface without concern for how the particular functionality is implemented.

Spreadsheet applications 306 represents a plurality of different spreadsheet software applications. In addition, spreadsheet applications 306 may reside within data processing system 300, be downloaded from a storage device, such as a diskette, be imported from another data processing system coupled to data processing system 300 via a network, or any combination thereof. Spreadsheet applications 306 are spreadsheet software applications that contain electronic spreadsheets, which include collected data that a user desires to compare one against another by using comparison tool application 308. Alternatively, spreadsheet applications 306 may represent one spreadsheet software application that contains a plurality of different electronic spreadsheets that the user wishes to compare.

Comparison tool application 308 is a software application designed to compare a plurality of electronic spreadsheets. However, it should be noted that illustrative embodiments are not limited to only comparing a plurality of electronic spreadsheets. Illustrative embodiments may compare relational databases or any other type of data that is stored in a structured format, such as in columns and rows.

A user of data processing system 300 utilizes comparison tool application 308 to compare spreadsheet applications 306. Comparison tool application 308 includes spreadsheet file information 310, mapping information 312, comparison rules 314, and comparison report 316. However, it should be noted that comparison tool application 308 is only shown for illustration purpose and may include more or fewer components as necessary to accomplish processes of illustrative embodiments.

A user inputs spreadsheet file information 310 into comparison tool application 308 by utilizing user input devices, such as keyboard 106 and mouse 110 in FIG. 1. Spreadsheet file information 310 may include information, such as, for example, the names and/or identification numbers of the spreadsheet files to be compared, the specific columns within the spreadsheet files to be compared, and the specific row numbers of the column headers to start gathering data within the spreadsheet files to be compared. However, it should be noted that spreadsheet file information 310 may include any information necessary for comparison tool application 308 to identify the data to be compared.

Comparison tool application 308 uses spreadsheet file information 310 to retrieve the appropriate data for comparison from spreadsheet applications 306. Comparison tool application 308 may use the column header row number information to logically capture the column header names. Comparison tool application 308 may use the logically captured column header names to facilitate data mapping and comparison later on in the data comparison process. However, it should be noted that illustrative embodiments are not restricted to utilizing column header names to facilitate data mapping and comparison. Illustrative embodiments may map and compare data without using column headers.

A user also inputs mapping information 312 into comparison tool application 308. Mapping information 312 includes instructions to map data from one spreadsheet file within spreadsheet applications 306 to associated or like data in another spreadsheet file within spreadsheet applications 306. More specifically, mapping information 312 directs comparison tool application 308 to map data within a specified column from one spreadsheet file to a specified column within another spreadsheet file. For example, the user inputs mapping information 312 to direct comparison tool application 308 to map data within column B of spreadsheet File 1, which has a column header name of “Purchase Order Number”, to associated data within column C of spreadsheet File 2, which has a column header name of “PO Num”. It should be noted that the column header names are obtained from the user inputted information contained within spreadsheet file information 310. The purchase order number data within specified column B from File 1 is associated with the purchase order data within column C from File 2 even though the column and header names of the specified columns in each of the spreadsheet files is different. Consequently, comparison tool application 308 is able to compare associated data within the different spreadsheet files by using mapping information 312.

In addition, the user individually inputs or selects comparison rules 314 for use by comparison tool application 308. Comparison rules 314 include rules for comparing data in specified spreadsheet files within spreadsheet applications 306. Comparison rules 314 may include rules, such as, for example, ignore case sensitivity, ignore data format, ignore data prefixes, ignore data postfixes, ignore specific columns, and ignore white space differentiation.

The ignore case sensitivity rule means that comparison tool application 308 ignores any differences in upper and lower case letters in the specified data to be compared. If the user selects the ignore case sensitivity rule, then comparison tool application 308 ignores any differences in case and perceives, for example, “PROJECT NAME” and “project name” as equivalent data. The ignore data format rule means that comparison tool application 308 ignores any differences in the format of the data to be compared. If the user selects the ignore data format rule, then comparison tool application 308 ignores any differences in data format and perceives, for example, “11-25-2004” and “25-11-2004” as equivalent data.

The ignore data prefixes rule means that comparison tool application 308 ignores user specified prefixes attached to the specified data to be compared. If the user selects the ignore data prefixes rule, then comparison tool application 308 ignores the specified prefix attached to the data and perceives, for example, “PO” and “#PO” as equivalent data. It should be noted that in the immediately preceding example the # symbol was the user specified prefix. The ignore data postfixes rule means that comparison tool application 308 ignores user specified postfixes attached to the specified data to be compared. If the user selects the ignore data postfixes rule, then the comparison tool application 308 ignores the specified postfix attached to the data and perceives, for example, “project name” and “project name*” as equivalent data. It should be noted that in the immediately preceding example the * symbol was the user specified postfix.

The ignore specific columns rule means that comparison tool application 308 ignores any specified column within the spreadsheet files to be compared. The ignore white space differentiation rule means that comparison tool application 308 ignores any differences in the white space areas within the spreadsheets to be compared. A white space area within a spreadsheet is an area that does not contain any data, headers, or names. In other words, white space areas contain nothing. Consequently, if a user selects the ignore white space differentiation rule, then comparison tool application 308 ignores all areas within the selected spreadsheet files that contain nothing.

As a result of individually selecting comparison rules 314, the user is able to configure how comparison tool application 308 compares the data contained in the specified columns in spreadsheet applications 306. However, it should be noted that illustrative embodiments are not limited to the above-listed comparison rules. Illustrative embodiments may include more or fewer comparison rules that are necessary to accomplish processes of illustrative embodiments.

Comparison tool application 308 generates comparison report 316 after performing the data comparison process. Comparison report 316 is a report that includes the data comparison of a plurality of user selected spreadsheet files. After generating comparison report 316, comparison tool application 308 stores comparison report 316 in a non-volatile storage device, such as, for example, ROM 224, hard disk 226, or CD-ROM 230 in FIG. 2. In addition, comparison tool application 308 displays comparison report 316 in a screen display, such as, for example, video display terminal 104 in FIG. 1, for the user to review.

A user of data processing system 300 utilizes GUI 318 to interact with applications residing in data processing system 300, such as spreadsheet applications 306 and comparison tool application 308. GUI 318 is a graphics-based user interface that incorporates movable windows and icons, which may be manipulated by a keyboard or mouse. Typically, GUI 318 is the standard way a user interacts with a computer.

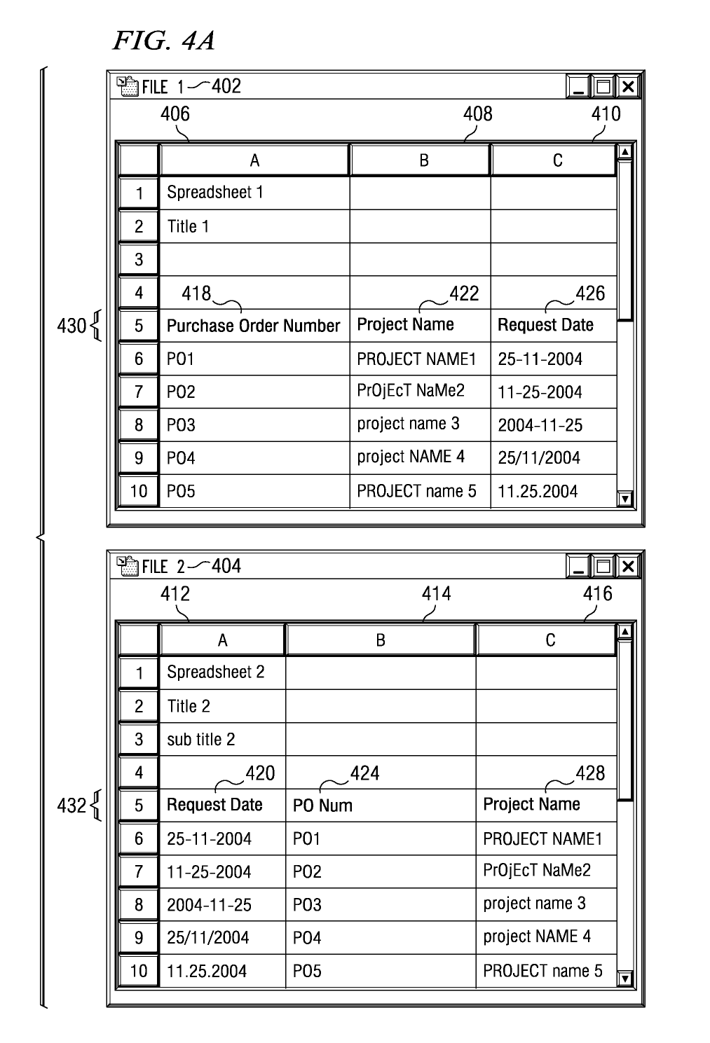

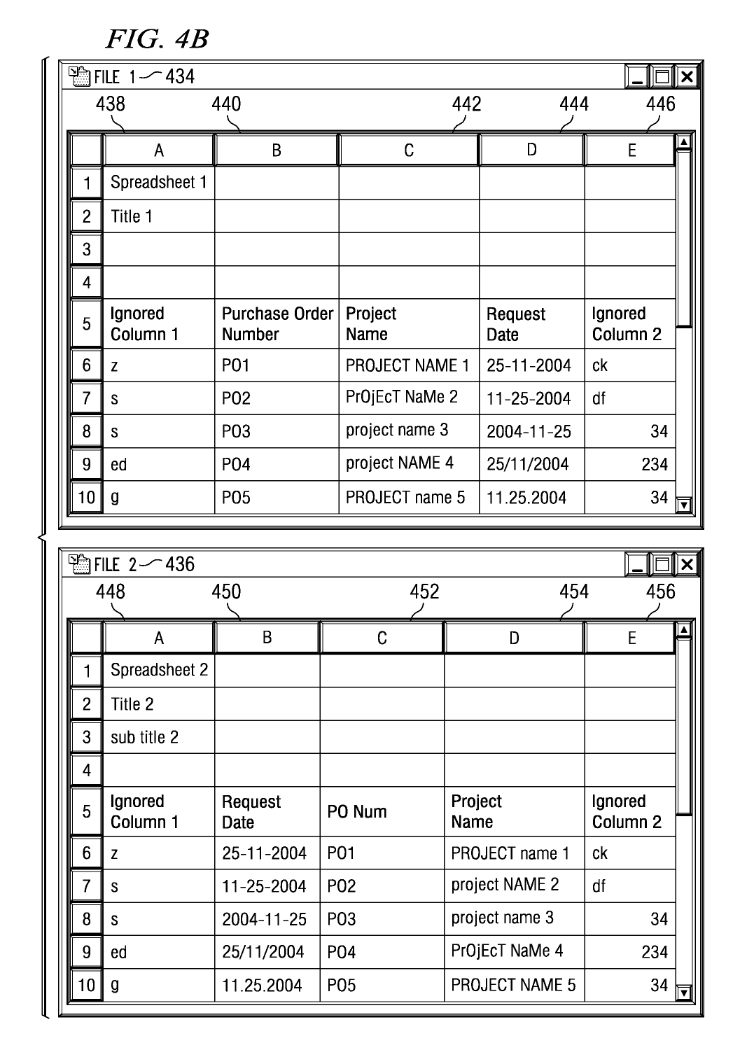

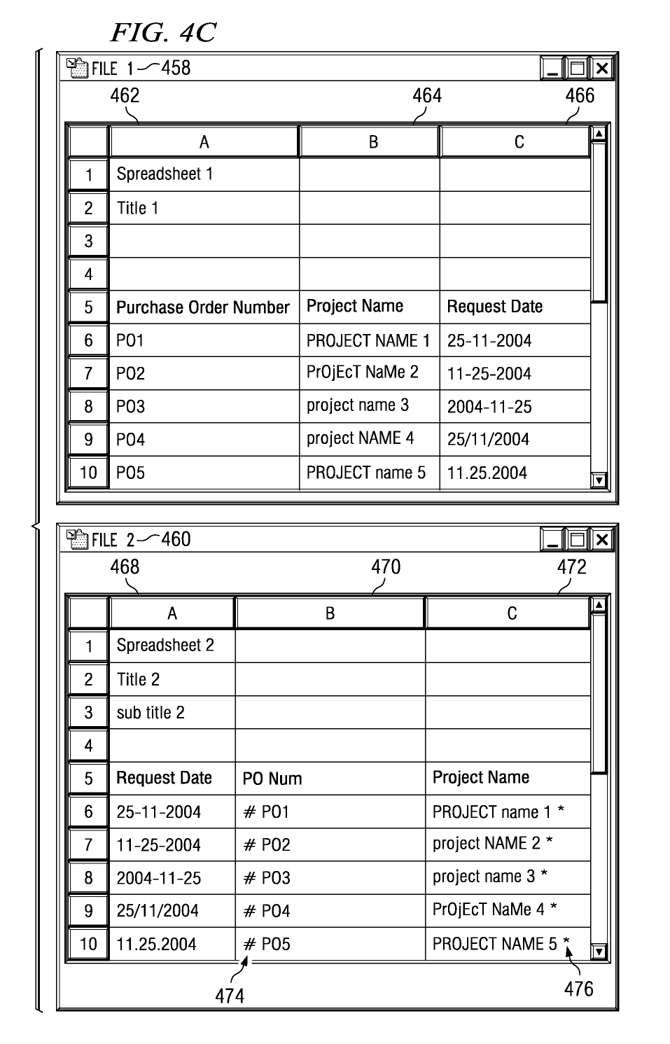

With reference now to FIGS. 4A, 4B, and 4C, exemplary illustrations of data to be compared from a plurality of spreadsheets is depicted in accordance with an illustrative embodiment. FIG. 4A includes spreadsheet File 1 402 and spreadsheet File 2 404. Spreadsheet File 1 402 and spreadsheet File 2 404 may, for example, be spreadsheet applications 306 in FIG. 3. A user selects, by inputting spreadsheet file information, such as, for example, spreadsheet file information 310 in FIG. 3, spreadsheet File 1 402 and spreadsheet File 2 404 for data comparison by a spreadsheet comparison tool, such as, for example, comparison tool application 308 in FIG. 3. In addition, the user selects mapping information and comparison rules, such as, for example, mapping information 310 and comparison rules 312 in FIG. 3, in order for the spreadsheet comparison tool to generate an intelligible comparison report, such as, for example, comparison report 314 in FIG. 3, after performing the data comparison of spreadsheet File 1 402 and spreadsheet File 2 404.

Spreadsheet File 1 402 includes three columns: column A 406, column B 408, and column C 410. Spreadsheet File 2 404 also includes three columns: column A 412, column B 414, and column C 416. However, the data contained in columns A 406, B 408, and C 410 of spreadsheet File 1 402 do not directly match the data contained in columns A 412, B 414, and C 416 of spreadsheet File 2 404. Consequently, a comparison of data as-is is not possible because column A 406 contains header 418 “Purchase Order Number” and column A 412 contains header 420 “Request Date”. The column header names are obtained from the user inputted information contained within the spreadsheet file information.

As a result, subsequent rows after header 418 contain purchase order data and subsequent rows after header 420 contain request date data. Similarly, column B 408 includes header 422 “Project Name” with related project name data below it and column B 414 includes header 424 “PO Num” with related purchase order number data below it. Also, column C 410 includes header 426 “Request Date” with related request date data below it and column C 416 includes header 428 “Project Name” with related project name data below it.

Even though spreadsheet File 1 402 and spreadsheet File 2 404 have the same number of columns, the sequence of data contained within these columns is not the same. As shown above, column A 406 contains purchase order number data, whereas column A 412 contains request date data. However, column B 414 also contains purchase order number data. Therefore, a user utilizing an illustrative embodiment may select, or input, mapping information to direct the spreadsheet comparison tool to map the data from column A 406 to the data in column B 424 for comparison purposes. Similarly, a user may input mapping information to direct the spreadsheet comparison tool to map data from column B 422 to data in column C 428 and data from column C 426 to data in column A 420 for comparison purposes.

Further, headers 418, 422, and 426 do not exactly match headers 420, 424, and 428 even though the data in spreadsheet File 1 402 is the same, or associated with, the data in spreadsheet File 2 404. For example, header 418 reads: “Purchase Order Number;” whereas header 424 reads: “PO Num.” Both header 418 and header 424 refer to the same type data but do not exactly match with regard to spelling. Thus, a user utilizing an illustrative embodiment may select a comparison rule to ignore all header rows or specifically identified header rows in both spreadsheet File 1 402 and spreadsheet File 2 404 to generate an intelligible comparison report.

Furthermore, the data contained in column C 410 and column A 412 do not have a consistent format. For example, even though the data has the same Nov. 25, 2004 date, the date is expressed in different formats, such as 11-25-2004, 25-11-2004, 2004-11-25, 25/11/2004, and 11.25.2004. Consequently, a user utilizing an illustrative embodiment may select a comparison rule to ignore data format in both spreadsheet File 1 402 and spreadsheet File 2 404 or just in specified columns to generate an intelligible comparison report.

Moreover, the data contained in column B 408 and column C 416 includes upper and lower case differentiations. For example, even though the data refers to project names 1-5, the project names contain differences in upper and lower case letters, such as PROJECT NAME 1, PrOjEcT NaMe 2, project name 3, project NAME 4, and PROJECT name 5. As a result, a user utilizing an illustrative embodiment may select a comparison rule to ignore case sensitivity, or upper and lower case differentiations, within the data to be compared in spreadsheet File 1 402 and spreadsheet File 2 404 or only in specified columns in order to generate an intelligible comparison report.

Also, spreadsheet File 1 402 and spreadsheet File 2 404 include white space differentiations. Consequently, a user utilizing illustrative embodiments may input a specific row number within the spreadsheet file information to direct the spreadsheet comparison tool to start gathering data for comparison from that user specified row forward. For example, a user may input row number 5 430 and row number 5 432 within the spreadsheet file information to direct the spreadsheet comparison tool to gather data for comparison from rows 5-10 and ignore rows 1-4. Thus, a user utilizing an illustrative embodiment may select a comparison rule to ignore white space differentiations in spreadsheet File 1 402 and spreadsheet File 2 404 in order to generate an intelligible comparison report.

Referring now to FIG. 4B, FIG. 4B includes spreadsheet File 1 434 and spreadsheet File 2 436. Spreadsheet File 1 434 includes five columns: column A 438, column B 440, column C 442, column D 444, and column E 446. Spreadsheet File 2 436 also includes five columns: column A 448, column B 450, column C 452, column D 454, and column E 456. However, a user may not desire to compare all the data columns contained within spreadsheet File 1 434 and spreadsheet File 2 436. For example, the user may only desire to compare data in columns 440, 442, 444, 450, 452, and 454. Consequently, in addition to inputting mapping information within the spreadsheet comparison tool to map data from column B 440 to column C 452, column C 442 to column D 454, and column D 444 to column B 450, the user utilizing an illustrative embodiment may select a comparison rule to ignore specified columns in spreadsheet File 1 434 and spreadsheet File 2 436. As a result, the spreadsheet comparison tool intentionally ignores data contained in column A 438, column E 446, column A 448, and column E 456 during the data comparison process. Alternatively, instead of selecting which columns the spreadsheet comparison tool is to ignore, a user utilizing another illustrative embodiment may select which columns the spreadsheet comparison tool is to include in the data comparison process.

Turning now to FIG. 4C, FIG. 4C includes spreadsheet File 1 458 and spreadsheet File 2 460. Spreadsheet File 1 458 includes three columns: column A 462, column B 464, and column C 466. Spreadsheet File 2 460 also includes three columns: column A 468, column B 470, and column C 472. However, a user may not desire to compare all the data contained within a specified column. For example, the user may not wish for the spreadsheet comparison tool to include data prefixes and/or postfixes in the data comparison process. Consequently, in addition to inputting mapping information within the spreadsheet comparison tool to map data from column A 462 to column B 470, column B 464 to column C 472, and column C 466 to column A 468, the user utilizing an illustrative embodiment may select a comparison rule to ignore user specified data prefixes and/or postfixes in spreadsheet File 1 458 and spreadsheet File 2 460. For example, in this particular illustration of FIG. 4C, the user specifies that the spreadsheet comparison tool is to ignore a # prefix and a*postfix for data within column B 470 and column C 472, respectively. As a result, the spreadsheet comparison tool intentionally ignores data prefixes 474 in column B 470 and data postfixes 476 in column C 472 during the column mapped data comparison process to generate an intelligible comparison report.

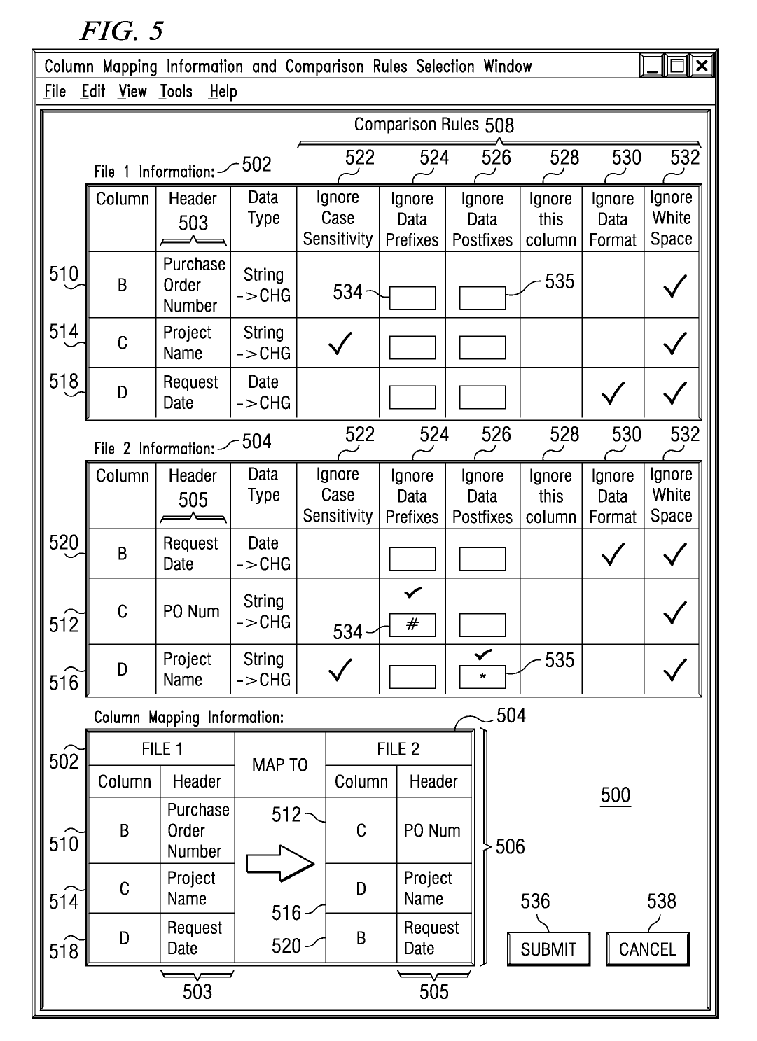

With reference now to FIG. 5, a pictorial representation of a column mapping information and comparison rules selection window is depicted in accordance with an illustrative embodiment. A spreadsheet comparison tool, such as, for example, comparison tool application 308 in FIG. 3, may display column mapping information and comparison rules selection window 500 in, for example, a display screen, such as, for example, video display terminal 104 in FIG. 1, for a user to view and manipulate using user input devices, such as, for example, keyboard 106 and mouse 110 in FIG. 1.

Column mapping information and comparison rules selection window 500 includes information for user specified spreadsheet File 1 502 and user specified spreadsheet File 2 504 for data comparison. It should be noted that the user specifies which spreadsheet files the spreadsheet comparison tool is to compare by inputting spreadsheet file information, such as, for example, spreadsheet file information 310 in FIG. 3. The spreadsheet file information includes the specific names and/or identification numbers of the files to be compared. In addition, the spreadsheet file information also contains the specific columns to be compared within the specified spreadsheet files. Further, the spreadsheet file information may include the specific row numbers, such as, for example, row number 5 430 and 432 in FIG. 4A, to direct the spreadsheet comparison tool to start gathering comparison data from the specified spreadsheet files.

The spreadsheet comparison tool uses the spreadsheet file information to retrieve the appropriate data for comparison from the specified spreadsheet files. Also, the spreadsheet comparison tool may use column header row number information to logically capture column header names 503 and 505, such as, for example, the column header names in row number 5 430 and 432 in FIG. 4A. The spreadsheet comparison tool may use the logically captured column header names to facilitate data mapping and comparison.

The user utilizes column mapping information and comparison rules selection window 500 to input or select column mapping information 506, such as mapping information 312 in FIG. 3, and comparison rules 508, such as comparison rules 314 in FIG. 3, to direct the spreadsheet comparison tool how to compare the specified data in spreadsheet File 1 502 and spreadsheet File 2 504. Column mapping information 506 instructs the spreadsheet comparison tool to map data from one specified column within a specified spreadsheet file to another specified column within another specified spreadsheet file. For example, in this particular illustration of FIG. 5, column B 510 with the header “Purchase Order Number” in File 1 502 is mapped to column C 512 with the header “PO Num” in File 2 504, column C 514 with the header “Project Name” in File 1 502 is mapped to column D 516 with the header “Project Name” in File 2 504, and column D 518 with the header “Request Date” in File 1 502 is mapped to column B 520 with the header “Request Date” in File 2 504.

Column mapping information and comparison rules selection window 500 includes checkboxes for a user to select comparison rules 508, such as ignore case sensitivity 522, ignore data prefixes 524, ignore data postfixes 526, ignore this column 528, ignore data format 530, and ignore white space 532. However, it should be noted that illustrative embodiments are not limited to the use of checkboxes to select comparison rules. Illustrative embodiments may utilize any form of selection process, such as, for example, radio buttons, to select comparison rules 508.

In addition, the checkboxes also may contain text boxes for user input. For example, in this particular illustration of FIG. 5, the checkboxes for ignore data prefixes 524 and ignore data postfixes 526 contain text boxes 534 and 535, respectively. Alternatively, text boxes 534 and 535 may, for example, only appear after a user places a checkmark within the checkbox for ignore data prefixes 524 and ignore data postfixes 526, respectively. A user utilizes text box 534 to input specific data prefixes, such as, for example, data prefixes 474 in FIG. 4C, which the spreadsheet comparison tool will ignore during the data comparison process. A user utilizes text box 535 to input specific data postfixes, such as, for example, data postfixes 476 in FIG. 4C, which the spreadsheet comparison tool will ignore during the data comparison process.

Also, in this particular illustration of FIG. 5, the user selects comparison rules ignore case sensitivity 522 for column C 514, ignore data format 530 for column D 518, and ignore white space 532 for columns B 510, C 514, and D 518 in File 1 502. The user also selects comparison rules ignore case sensitivity 522 for column D 516, ignore data prefixes 524 for column C 512, ignore data postfixes 526 for column D 516, ignore data format 530 for column B 520, and ignore white space 532 for columns B 520, C 512, and D 516 in File 2 504. Further, the user inputs within text box 534 for column C 512 a # symbol to specify the exact data prefix the spreadsheet comparison tool is to ignore during data comparison. Furthermore, the user inputs within text box 535 for column D 516 a*symbol to specify the exact data postfix the spreadsheet comparison tool is to ignore during data comparison. After entering column mapping information 506 and comparison rules 508, the user “click” on submit button 536 with a mouse to start the data comparison process according to the user's selections in column mapping information and comparison rules selection window 500. Alternatively, the user may click cancel button 538 to close column mapping information and comparison rules selection window 500.

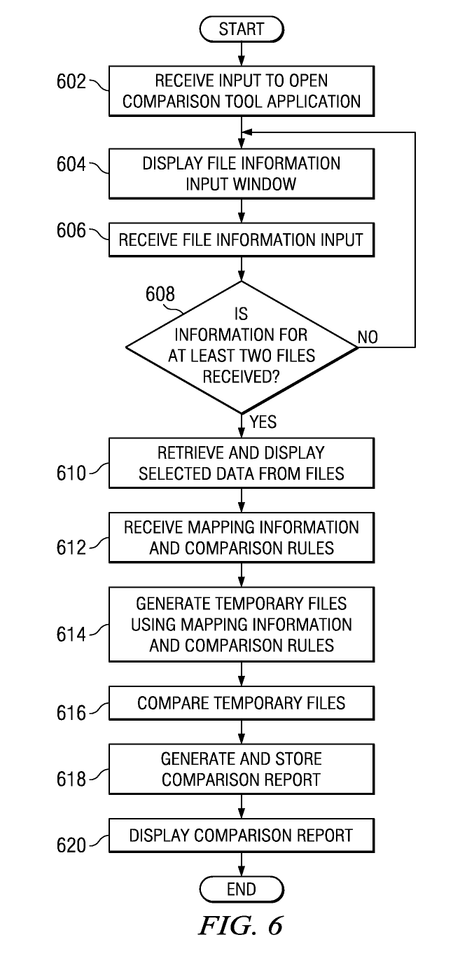

With reference now to FIG. 6, a flowchart illustrating an exemplary process for comparing data from a plurality of spreadsheets is shown in accordance with an illustrative embodiment. The process shown in FIG. 6 may be implemented in a spreadsheet comparison tool, such as, for example, comparison tool application 308 in FIG. 3.

The process begins when the spreadsheet comparison tool receives an input from a user input device, such as, for example, keyboard 106 or mouse 110 in FIG. 1, to open the spreadsheet comparison tool (step 602). After receiving the user input to open the spreadsheet comparison tool in step 602, the spreadsheet comparison tool displays a spreadsheet file information input window in a display screen, such as, for example, video display terminal 104 in FIG. 1, for the user to input spreadsheet file information, such as, for example, spreadsheet file information 310 in FIG. 3, regarding the particular spreadsheets to be compared by the spreadsheet comparison tool (step 604). The spreadsheet file information input by the user regarding the particular spreadsheets to be compared by the spreadsheet comparison tool may, for example, include the specific names of the electronic spreadsheets, such as spreadsheet File 1 402 and spreadsheet File 2 404 in FIG. 4A. In addition, the spreadsheet file information also may include specific columns to be compared and column header rows to indicate a starting point for gathering data for comparison within the spreadsheets, such as columns A 406 and B 414 and headers “Purchase Order Number” 418 and “PO Num” 424 in FIG. 4A. Of course, it should be noted that illustrative embodiments may include more or less information within the spreadsheet file information input window to specifically identify the spreadsheets and data to be compared by the spreadsheet comparison tool.

Subsequent to the user inputting the file information within the displayed file information input window in step 604, the spreadsheet comparison tool receives the inputted file information (step 606) and makes a determination as to whether file information for at least two different spreadsheet files is received (step 608). If file information for at least two different spreadsheet files is not received by the spreadsheet comparison tool application, no output of step 608, then the process returns to step 604 where the spreadsheet comparison tool application once again displays the file information input window. If file information for at least two different spreadsheet files is received by the spreadsheet comparison tool application, yes output of step 608, then the spreadsheet comparison tool retrieves and displays the user selected data from the particular spreadsheets to be compared in a column mapping information and comparison rules selection window, such as, for example, column mapping information and comparison rules selection window 500 in FIG. 5 (step 610).

After retrieving and displaying the selected data from the spreadsheet files in step 610, the spreadsheet comparison tool receives user inputted column mapping information and comparison rules, such as column mapping information 506 and comparison rules 508 in FIG. 5, which the spreadsheet comparison tool uses to compare the data from the plurality of spreadsheets (step 612). Subsequent to receiving the column mapping information and comparison rules, the spreadsheet comparison tool generates temporary files for the associated plurality of spreadsheets to be compared using the column mapping information and comparison rules (step 614). Then, the spreadsheet comparison tool compares the temporary spreadsheet files (step 616).

After comparing the temporary spreadsheet files in step 616, the spreadsheet comparison tool generates a comparison report, such as, for example, comparison report 316 in FIG. 3 (step 618). In addition to generating the comparison report, the spreadsheet comparison tool stores the comparison report in a storage device, such as, for example, ROM 224, hard disk 226, or CD-ROM 230 in FIG. 2. Further, concurrent with or subsequent to the spreadsheet comparison tool storing the comparison report in step 618, the spreadsheet comparison tool displays the comparison report on the screen display for the user to review (step 620). The process terminates thereafter.

Thus, illustrative embodiments provide a computer implemented method, system, and computer useable program code for comparing data from a plurality of spreadsheets. The invention can take the form of an entirely hardware embodiment, an entirely software embodiment or an embodiment containing both hardware and software elements. In a preferred embodiment, the invention is implemented in software, which includes but is not limited to firmware, resident software, microcode, et cetera.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a ROM, a rigid magnetic disk, and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters also may be coupled to the system to enable the data processing system to become coupled to other data processing systems or remote printers or storage devices through intervening private or public networks. Modems, cable modem, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for comparing data, the computer implemented method comprising:
responsive to retrieving data from a plurality of files according to file information, generating temporary files for the plurality of files from the retrieved data using mapping information and at least one of a plurality of comparison rules;
comparing the temporary files; and
generating a comparison report.

2. The computer implemented method of claim 1, further comprising:
storing the comparison report; and
displaying the comparison report.

3. The computer implemented method of claim 1, wherein the retrieved data is spreadsheet data or database data, and wherein the plurality of files are a plurality of spreadsheet files or a plurality of databases.

4. The computer implemented method of claim 1, wherein a user inputs the file information, and wherein the file information includes a name for each of the plurality of files to be compared, specific columns to be compared within each of the plurality of files, and specific rows within each of the plurality of files to start gathering data.

5. The computer implemented method of claim 4, wherein the specific rows include column header rows, and wherein the column header rows are used to logically capture column header names for data mapping and comparison.

6. The computer implemented method of claim 1, wherein the plurality of comparison rules include rules to ignore case sensitivity, data format, data prefixes, data postfixes, specific columns, and white space differentiation.

7. The computer implemented method of claim 1, wherein a user inputs the mapping information in order for a comparison tool application to perform the comparing step, and wherein the mapping information includes instructions to map data from one file within the plurality of files to associated data in another file within the plurality of files.

8. The computer implemented method of claim 7, wherein the mapping information is column mapping information.

9. The computer implemented method of claim 6, wherein a user selects which of the plurality of comparison rules a comparison tool application utilizes to perform the comparing step.

10. A data processing system for comparing data, comprising:
a bus system;
a storage device connected to the bus system, wherein the storage device includes a set of instructions; and
a processing unit connected to the bus system, wherein the processing unit executes the set of instructions to generate temporary files for a plurality of files from retrieved data using mapping information and at least one of a plurality of comparison rules in response to retrieving the data from the plurality of files according to file information, compare the temporary files, and generate a comparison report.

11. The data processing system of claim 10, wherein the processing unit executes a further set of instructions to store the comparison report and display the comparison report.

12. The data processing system of claim 10, wherein the retrieved data is spreadsheet data or database data, and wherein the plurality of files are a plurality of spreadsheet files or a plurality of databases.

13. The data processing system of claim 11, wherein the comparison report is stored in the storage device.

14. A computer program product for comparing data, the computer program product comprising:
a computer usable medium having computer usable program code embodied therein, the computer usable medium comprising:
computer usable program code configured to generate temporary files for a plurality of files from retrieved data using mapping information and at least one of a plurality of comparison rules in response to retrieving the data from the plurality of files according to file information;
computer usable program code configured to compare the temporary files; and
computer usable program code configured to generate a comparison report.

15. The computer program product of claim 14, further comprising:
computer usable program code configured to store the comparison report; and
computer usable program code configured to display the comparison report.

16. The computer program product of claim 14, wherein a user inputs the file information, and wherein the file information includes a name for each of the plurality of files to be compared, specific columns to be compared within each of the plurality of files, and specific rows within each of the plurality of files to start gathering data.

17. The computer program product of claim 16, wherein the specific rows include column header rows, and wherein the column header rows are used to logically capture column header names for data mapping and comparison.

18. The computer program product of claim 14, wherein a user inputs the mapping information in order for a comparison tool application to execute the computer usable program code configured to compare the temporary files, and wherein the mapping information includes instructions to map data from one file within the plurality of files to associated data in another file within the plurality of files.

19. The computer program product of claim 14, wherein the plurality of comparison rules include rules to ignore case sensitivity, data format, data prefixes, data postfixes, specific columns, and white space differentiation.

20. The computer program product of claim 18, wherein the mapping information is column mapping information.
